(19) United States
(12) Patent Application Publication
(10) Pub. No.: US 2025/0153750 A1
(43) Pub. Date: May 15, 2025

(54) SYSTEMS AND METHODS FOR PREDICTING RAILROAD TRACK SURFACE DEGRADATION

(71) Applicant: BNSF Railway Company, Fort Worth, TX (US)

(72) Inventors: Ranjan Dash, Flower Mound, TX (US); John D. Martin, Arlington, TX (US); Adam L. Miller, Broomfield, CO (US); Keshav Subramaniam, Irving, TX (US); Charity M. Duran, Fort Worth, TX (US); Srilakshmi Tayi, Flower Mound, TX (US); Yasha Hajizeinalibiouki, Plano, TX (US)

(73) Assignee: BNSF Railway Company, Fort Worth, TX (US)

(21) Appl. No.: 18/508,925

(22) Filed: Nov. 14, 2023

(51) Int. Cl. B61L 27/53; G01M 5/00; G06Q 10/1093; G06Q 10/20

(52) U.S. Cl. CPC B61L 27/53; G01M 5/0058; G06Q 10/1097; G06Q 10/20

(57) ABSTRACT

According to some embodiments, a method includes accessing track geometry data for a railroad track. The track geometry data includes historical measurements for a plurality of types of surface conditions of the railroad track over a period of time. The method further includes determining, by analyzing the track geometry data for a particular type of surface condition, a plurality of measurements that exceed a predetermined value. The method further includes identifying, by clustering the plurality of measurements that exceed the predetermined value, a particular track location on the railroad track as a progressive defect location. The method further includes determining, using a remaining useful life model and the track geometry data for the particular type of surface condition at the progressive defect location, a future time when the particular type of surface condition at the progressive defect location will exceed a predetermined limit.

### TECHNICAL FIELD

This disclosure generally relates to railroad track surface conditions, and more specifically to systems and methods for predicting railroad track surface degradation.

### BACKGROUND

Trains, which typically include a locomotive engine and one or more train cars, travel over a railroad track to transport passengers and freight. A typical railroad track includes two rails laid down in parallel to each other, which may provide a surface over which the wheels of the train cars can be moved and guided. The parallel rail lines may be attached to cross ties laid down perpendicular to the rails to provide structural support to the railroad track. Each of the rails of the railroad track may be composed of multiple rail sections. For example, each of the multiple rail sections may be connected to another rail section, end to end, to form a rail of the railroad track.

Due to several factors such as weather and train traffic, the surface of a railroad track may degrade over time. For example, a rail of the railroad track may develop a dip or a rise that may continually get worse over time. As another example, the difference in elevation between a left rail and a right rail of the railroad track may increase over time, thereby causing the railroad track to not be level. Track surface degradations such as these are dangerous and must be monitored and repaired. Current techniques to monitor track surface degradations, however, are generally reactive in nature and are addressed after problems have progressed past an unacceptable level.

### SUMMARY

The present disclosure achieves technical advantages as systems, methods, and computer-readable storage media that provide functionality for predicting railroad track surface degradation. The present disclosure provides for a system integrated into a practical application with meaningful limitations that may include accessing track geometry data for a railroad track. The track geometry data includes historical measurements for a plurality of types of surface conditions of the railroad track over a period of time and may be captured by sensors of an aerial vehicle (e.g., drone), a locomotive, a robotic cart, a railroad inspection car, and the like. Other meaningful limitations of the system integrated into a practical application include: determining, by analyzing the track geometry data for a particular type of surface condition, a plurality of measurements that exceed a predetermined value; identifying, by clustering the plurality of measurements that exceed the predetermined value, a particular track location on the railroad track as a progressive defect location; and determining, using a remaining useful life model and the track geometry data for the particular type of surface condition at the progressive defect location, a future time when the particular type of surface condition at the progressive defect location will exceed a predetermined limit.

The present disclosure solves the technological problem of a lack of technical functionality for monitoring railroad track defects by providing methods and systems that automatically analyze track geometry data for a railroad track and then predict a future time when a particular type of surface condition at a progressive defect location will exceed a predetermined limit. The technological solutions provided herein, and missing from conventional systems, are more than a mere application of a manual process to a computerized environment, but rather include functionality to implement a technical process to supplement current manual solutions for monitoring railroad track defects by providing a mechanism for automatically determining a future time when a particular type of surface condition at a progressive defect location will exceed a predetermined limit. In doing so, the present disclosure goes well beyond a mere application the manual process to a computer.

Unlike existing solutions where personnel may be required to manually monitor railroad track defects, embodiments of this disclosure provide systems and methods that automatically determine a future time when a particular type of surface condition of a railroad track will exceed a predetermined limit. By providing a future time when a particular type of surface condition of a railroad track will exceed a predetermined limit, the safety of railroad tracks may be increased and availability/efficiency of the railroad track may be increased. Other technical advantages will be readily apparent to one skilled in the art from the following figures, descriptions, and claims. Moreover, while specific advantages have been enumerated above, various embodiments may include all, some, or none of the enumerated advantages.

Accordingly, the present disclosure discloses concepts inextricably tied to computer technology such that the present disclosure provides the technological benefit of implementing functionality to automatically analyze track geometry data for a railroad track and then predict a future time when a particular type of surface condition at a progressive defect location will exceed a predetermined limit. The systems and techniques of embodiments provide improved systems by providing capabilities to perform functions that are currently performed manually and to perform functions that are currently not possible.

It is an object of the invention to provide a system for automatically analyzing track geometry data for a railroad track and then predict a future time when a particular type of surface condition at a progressive defect location will exceed a predetermined limit. It is a further object of the invention to provide methods of automatically analyzing track geometry data for a railroad track and then predict a future time when a particular type of surface condition at a progressive defect location will exceed a predetermined limit. It is still a further object of the invention to provide a computer-based tool for automatically analyzing track geometry data for a railroad track and then predict a future time when a particular type of surface condition at a progressive defect location will exceed a predetermined limit. These and other objects are provided by the present disclosure, including at least the following embodiments.

In one particular embodiment, a system includes one or more memory units and one or more computer processors communicatively coupled to the one or more memory units. The one or more computer processors are configured to access track geometry data for a railroad track. The track geometry data includes historical measurements for a plurality of types of surface conditions of the railroad track over a period of time. The one or more computer processors are further configured to determine, by analyzing the track geometry data for a particular type of surface condition, a plurality of measurements that exceed a predetermined value. The one or more computer processors are further configured to identify, by clustering the plurality of measurements that exceed the predetermined value, a particular track location on the railroad track as a progressive defect location. The one or more computer processors are further configured to determine, using a remaining useful life model and the track geometry data for the particular type of surface condition at the progressive defect location, a future time when the particular type of surface condition at the progressive defect location will exceed a predetermined limit.

In another embodiment, a method includes accessing track geometry data for a railroad track. The track geometry data includes historical measurements for a plurality of types of surface conditions of the railroad track over a period of time. The method further includes determining, by analyzing the track geometry data for a particular type of surface condition, a plurality of measurements that exceed a predetermined value. The method further includes identifying, by clustering the plurality of measurements that exceed the predetermined value, a particular track location on the railroad track as a progressive defect location. The method further includes determining, using a remaining useful life model and the track geometry data for the particular type of surface condition at the progressive defect location, a future time when the particular type of surface condition at the progressive defect location will exceed a predetermined limit.

In another embodiment, one or more computer-readable non-transitory storage media embodies instructions that, when executed by a processor, cause the processor to perform operations that include accessing track geometry data for a railroad track. The track geometry data includes historical measurements for a plurality of types of surface conditions of the railroad track over a period of time. The operations further include determining, by analyzing the track geometry data for a particular type of surface condition, a plurality of measurements that exceed a predetermined value. The operations further include identifying, by clustering the plurality of measurements that exceed the predetermined value, a particular track location on the railroad track as a progressive defect location. The operations further include determining, using a remaining useful life model and the track geometry data for the particular type of surface condition at the progressive defect location, a future time when the particular type of surface condition at the progressive defect location will exceed a predetermined limit.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a diagram illustrating a system for predicting railroad track surface degradation, according to particular embodiments.

FIGS. 2A-2C illustrate various track surface defects that may be analyzed by the system of FIG. 1, according to particular embodiments.

FIG. 3 is a flow diagram illustrating an example method for predicting railroad track surface degradation, according to particular embodiments.

FIG. 4 is a chart illustrating an overview of the data operations of the method of FIG. 3, according to particular embodiments.

FIG. 5A is a chart illustrating a clustering operation by the method of FIG. 3, according to particular embodiments.

FIG. 5B is a chart illustrating maximum absolute values of the highlighted defect region of FIG. 5A, according to particular embodiments.

FIG. 6 is a chart illustrating an example regression line determined by the method of FIG. 3, according to particular embodiments.

FIG. 7 is a chart illustrating example channel limits, according to particular embodiments.

FIG. 8 is an example computer system that can be utilized to implement aspects of the various technologies presented herein, according to particular embodiments.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

Trains, which typically include a locomotive engine and one or more train cars, travel over a railroad track to transport passengers and freight. A typical railroad track includes two rails laid down in parallel to each other, which may provide a surface over which the wheels of the train cars can be moved and guided. The parallel rail lines may be attached to cross ties laid down perpendicular to the rails to provide structural support to the railroad track. Each of the rails of the railroad track may be composed of multiple rail sections. For example, each of the multiple rail sections may be connected to another rail section, end to end, to form a rail of the railroad track.

Due to several factors such as weather and train traffic, the surface of a railroad track may degrade over time. For example, a rail of the railroad track may develop a dip or a rise that may continually get worse over time. As another example, the difference in elevation between a left rail and a right rail of the railroad track may increase over time, thereby causing the railroad track to not be level. Track surface degradations such as these are dangerous and must be monitored and repaired. Current techniques to monitor track surface degradations, however, are generally reactive in nature and are addressed after problems have progressed past an unacceptable level.

To address these and other problems with managing track surface degradation, the disclosed embodiments provide systems and methods for predicting railroad track surface degradation. In some embodiments, the disclosed systems and methods utilize historic track geometry channel data (e.g., track data for defects such as surface exceptions, dips and crosslevel) over a previous time period (e.g., the prior six-month period). Localized track segments with progressive defect amplitude are then identified using a clustering algorithm. A pattern is then fit for the channel increase over time for each location and the date at which the defect amplitude will exceed regulatory limits for the class of track is calculated.

The disclosed methods of predicting when and where a track geometry channel will exceed a set threshold, if left un-maintained, is predictive and proactive. This allows for scheduling maintenance before surface exceptions reach an unacceptable level (e.g., cross a regulatory threshold). Furthermore, the disclosed embodiments may revise or augment manual inspection schedules based on predicted dates when surface exceptions are to reach a certain threshold. For example, a geometry car may be scheduled to make one or more additional passes over a particular section of track based on predicted surface degradations. As a result, the safety of a railroad track may be greatly increased.

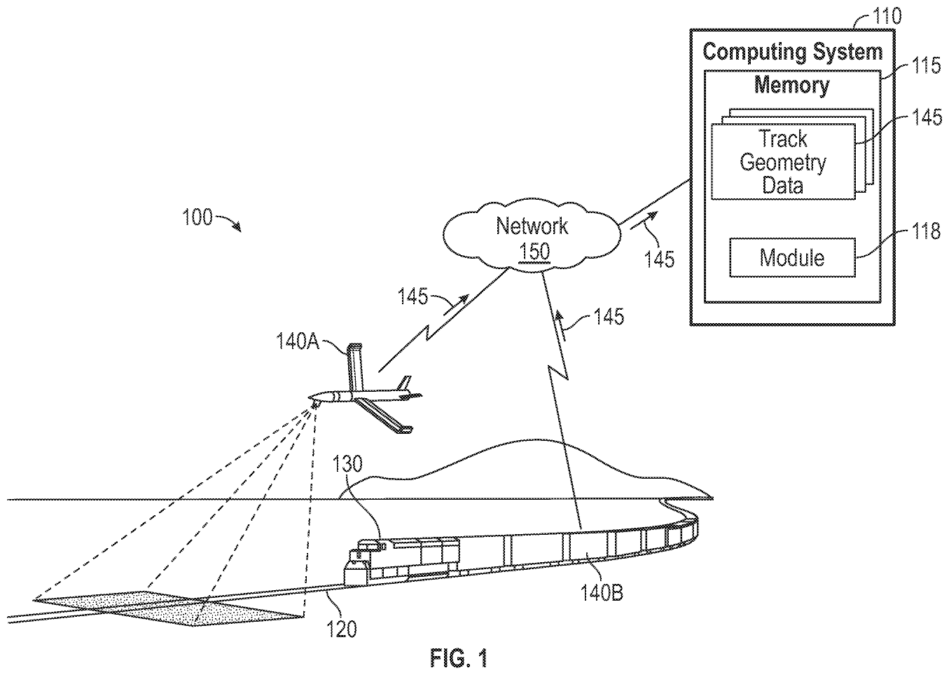

FIG. 1 is a diagram illustrating a track surface degradation prediction system 100, according to particular embodiments. Track surface degradation prediction system 100 includes a computing system 110, a railroad track 120, a train 130, one or more track geometry sensors 140, and a network 150. Computing system 110 includes memory 115 that stores track geometry data 145 and a track surface degradation prediction module 118.

In general, track surface degradation prediction module 118 of computing system 110 ingests track geometry data 145 from track geometry sensors 140 and applies various logic and algorithms to determine a future time when a particular type of surface condition at a specific location on railroad track 120 will exceed a predetermined limit. For example, track geometry sensors 140 may periodically traverse railroad track 120 and gather track geometry data 145 about railroad track 120. The track geometry data 145 may include various “channels” of geometry data such as surface exceptions, DIP31 exceptions, and CrossLevel exceptions, which are explained in more detail below. Track surface degradation prediction module 118 may then analyze each particular channel of track geometry data 145 in order to first identify specific locations on railroad track 120 that have defects that are progressively getting worse over time. For each specific defect location, track surface degradation prediction module 118 may apply logic (e.g., a remaining useful life model) in order to determine a future time when the particular type of surface condition will exceed a predetermined limit. Based on the predicted future time that the predetermined limit will be exceeded, track surface degradation prediction module 118 may perform one or more actions such as automatically generating an alert or automatically dispatching a repair technician to repair the progressive defect location. As a result, railroad track 120 may be proactively repaired, thereby increasing the safety and availability of railroad track 120. More details about the operation of track surface degradation prediction module 118 are discussed below.

It is noted that the functional blocks, and components thereof, of track surface degradation prediction system 100 of embodiments of the present invention may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of track surface degradation prediction system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of track surface degradation prediction system 100 described herein is provided for purposes of illustration, rather than by way of limitation and that functionalities described as being provided by different functional blocks may be combined into a single component or may be provided via computing resources disposed in a cloud-based environment accessible over a network, such as one of network 150.

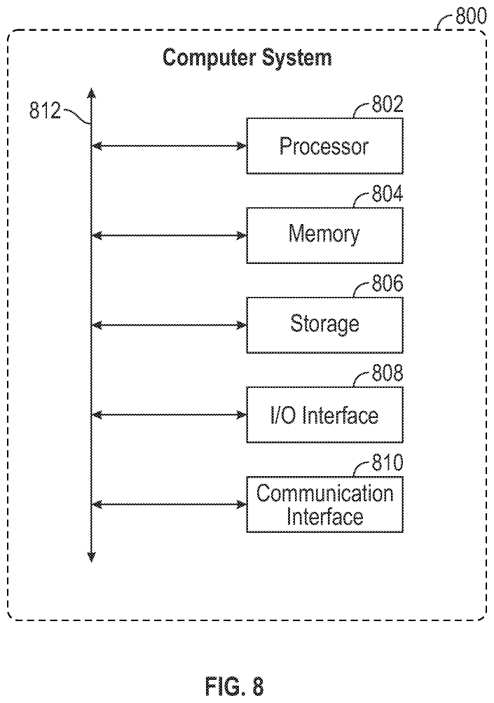

Computing system 110 may be configured to facilitate operations for predicting railroad track surface degradation, in accordance with embodiments of the present disclosure. The functionality of computing system 110 may be provided by the cooperative operation of the various components of computing system 110, as will be described in more detail below. Although FIG. 1 shows a single computing system 110, it will be appreciated that computing system 110 and its individual functional blocks may be implemented as a single device or may be distributed over multiple devices having their own processing resources, whose aggregate functionality may be configured to perform operations in accordance with the present disclosure. Furthermore, those of skill in the art would recognize that although FIG. 1 illustrates components of computing system 110 as single and separate blocks, each of the various components of computing system 110 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of computing system 110 may actually be part of a different component of computing system 110, and as such, the description of the particular functionality described for the particular component of computing system 110 is for illustrative purposes and not limiting in any way. A particular embodiment of computing system 110 is illustrated in reference to FIG. 8.

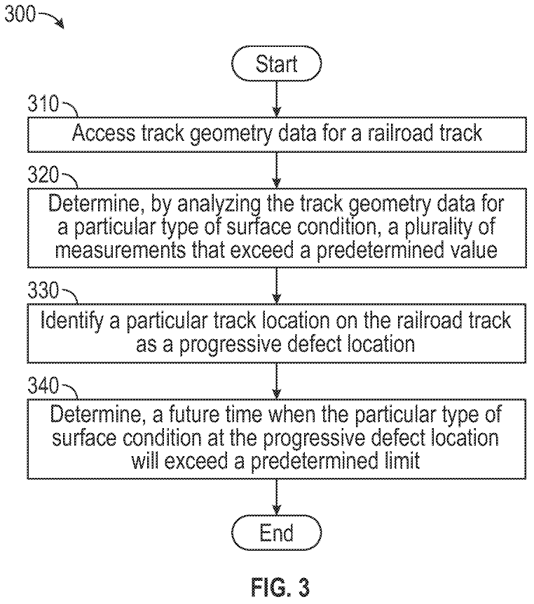

In some embodiments, track surface degradation prediction system 100 includes a track surface degradation prediction module 118 that performs one or more operations described herein. Track surface degradation prediction module 118 represents any suitable set of instructions, logic, or code embodied in a computer-readable storage medium. For example, track surface degradation prediction module 118 may be embodied in memory 115, a disk, a CD, or a flash drive. In particular embodiments, track surface degradation prediction module 118 may include instructions (e.g., a software application) executable by computer processor to perform one or more of the functions described herein. Particular methods that may be performed by track surface degradation prediction module 118 are described in more detail below with respect to FIG. 3.

Railroad tracks 120 of track surface degradation prediction system 100 are structures that allow train 130 to move by providing a surface for the wheels of train 130 to roll upon. In certain embodiments, railroad tracks 120 include rails, fasteners, railroad ties, ballast, etc. In some embodiments, railroad track 120 includes a left rail and a right rail.

Track geometry sensors 140 (e.g., 140A-140B) are vehicles or objects that capture track geometry data 145 about railroad tracks 120. For example, an aerial track geometry sensor 140A may be a drone or any other unmanned/manned aircraft that flies over railroad track 120 and utilizes multiple sensors to capture track geometry data 145. The sensors may include, for example, cameras, lidar, radar, and the like.

In some embodiments, track geometry sensors 140 include an inspection “geometry” car 140B. Geometry car 140B may be either manned or unmanned and may be a retrofitted passenger car with computers that analysts (either those onboard or remote) can monitor track conditions as the train travels along railroad track 120. Geometry car 140B may include onboard sensors such as cameras, lasers, radar and machine vision systems for surveying the railroad track 120 structure passing beneath.

Track geometry sensors 140 monitor and capture various characteristics of railroad track 120. The characteristics may include one or more of alignment (how straight the track is), crosslevel (the cant or pitch of the track), curvature (the actual degree of a curve), track gage (the distance between the rails), rail profile (wear and tear of the rails), ground conditions (the state of ballast rock and subgrade under the track), and rail joint conditions (the fastening system where two rail ends meet). The monitored characteristics are reported by track geometry sensors 140 in track geometry data 145.

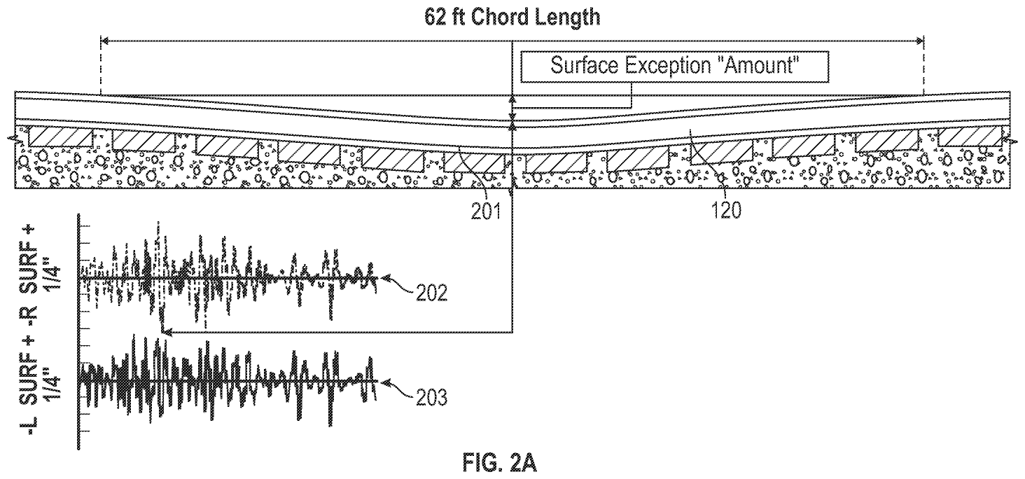

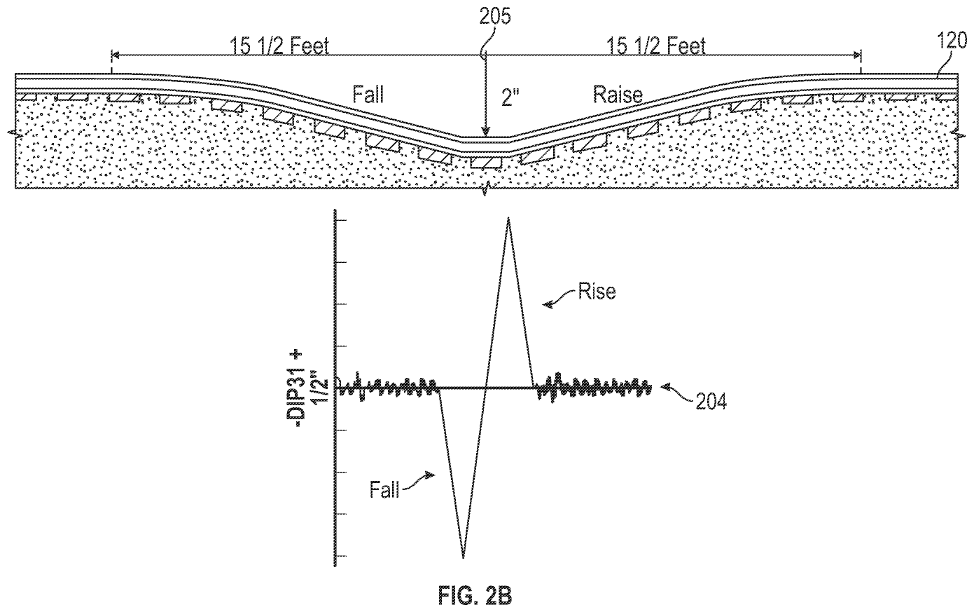

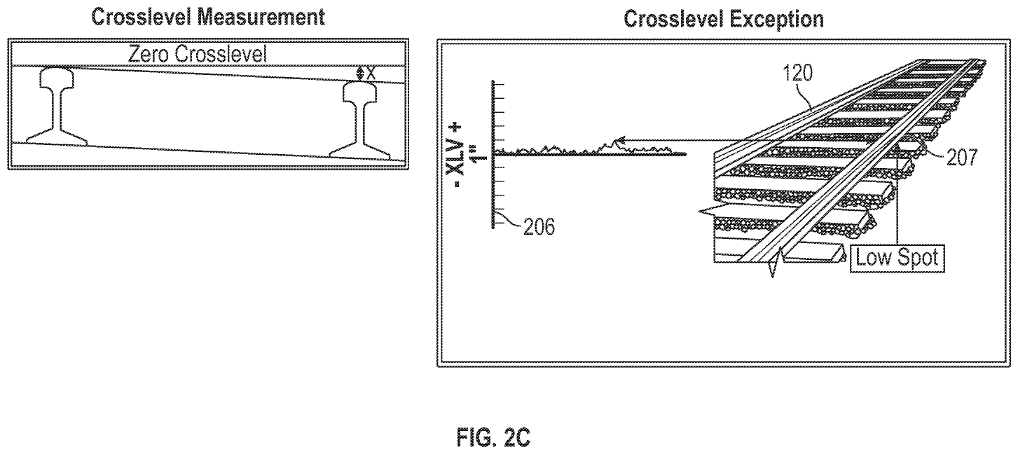

Track geometry data 145 is data about railroad track 120 that is captured by track geometry sensors 140 over a period of time. In general, track geometry data 145 contains various “channels” of various types of surface conditions of railroad track 120. The various types of surface conditions may include surface exceptions (i.e., rises or depressions in rails of railroad track 120) and CrossLevel exceptions (i.e., an amount of difference in elevation between top surfaces of the left and right rails of railroad track 120). The various types of surface conditions recorded in track geometry data 145 are illustrated in FIG. 2A-2C, discussed in more detail below.

FIG. 2A illustrates an example of a surface exception of railroad track 120 that may be included in track geometry data 145. In some embodiments, surface exceptions are measurements of the uniformity of rail surfaces measured in short distances along the tread of the rails of railroad track 120. In some embodiments, the surface is measured over a 62-foot chord distance as illustrated in FIG. 2A. In general, surface exceptions are determined by dips/depressions (negative signal “−”) or rises/humps (positive signal “+”) in the left and right rail surfaces of railroad track 120. The surface exceptions may be measured and recorded separately in track geometry data 145 for the left and right rails of railroad track 120. For example, as illustrated in FIG. 2A, the surface exceptions for the right rail (RSURF) are plotted in chart 202 and the surface exceptions for the left rail (LSURF) are plotted in chart 203. In the illustrated example of FIG. 2A, each tick mark of charts 202 and 203 are equal to ¼″. In this example, a dip surface exception at location 201 of the right rail of railroad track 120 is indicated to be a ¾″ depression.

FIG. 2B illustrates an example of a DIP31 exception of railroad track 120 that may be included in track geometry data 145. In some embodiments, a DIP31 exception is the largest change in elevation of the centerline of railroad track 120 within a 31-foot moving window. In general, DIP31 exceptions are determined by falls (negative signal “−”) or rises (positive signal “+”) in the centerline of railroad track 120. In FIG. 2B, the DIP31 exceptions for railroad track 120 are plotted in chart 204. In the illustrated example of FIG. 2B, each tick mark of chart 204 is equal to ½″. In this example, a DIP31 surface exception at location 205 of railroad track 120 is indicated to be a 2″ exception.

FIG. 2C illustrates an example of a crosslevel exception of railroad track 120 that may be included in track geometry data 145. In some embodiments, a crosslevel exception is the difference in elevation between the top surfaces of the left and right rails of railroad track 120 at a single point in a TANGENT track segment that is measured at right angles to the centerline of the track. In FIG. 2C, the crosslevel exceptions for railroad track 120 are plotted in chart 206. In the illustrated example of FIG. 2C, each tick mark of chart 206 is equal to 1″. In this example, a crosslevel exception at location 207 of railroad track 120 is indicated to be a 1″ exception.

Returning to FIG. 1, network 150 of track surface degradation prediction system 100 is any type of network that facilitates communication between components of track surface degradation prediction system 100. For example, network 150 may connect track geometry sensor 140 of track surface degradation prediction system 100 to computing system 110 of track surface degradation prediction system 100. One or more portions of network 150 may include an ad-hoc network, an intranet, an extranet, a virtual private network (VPN), a local area network (LAN), a wire-less LAN (WLAN), a wide area network (WAN), a wireless WAN (WWAN), a metropolitan area network (MAN), a portion of the Internet, a portion of the Public Switched Telephone Network (PSTN), a cellular telephone net-work, a 3G network, a 4G network, a 5G network, a Long Term Evolution (LTE) cellular network, a combination of two or more of these, or other suitable types of networks. One or more portions of network 150 may include one or more access (e.g., mobile access), core, and/or edge networks. Network 150 may be any communications network, such as a private network, a public network, a connection through Internet, a mobile network, a WI-FI network, a Bluetooth network, etc. Network 150 may include cloud computing capabilities. One or more components of track surface degradation prediction system 100 may communicate over network 150. For example, track geometry sensor 140 may communicate over network 150, including transmitting information (e.g., track geometry data 145) to computing system 110 and/or receiving information (e.g., updated scheduling) from computing system 110.

In operation, track surface degradation prediction module 118 of computing system 110 accesses track geometry data 145 from track geometry sensors 140 and determines a future time when a particular type of surface condition at a specific location on railroad track 120 will exceed a predetermined limit. First, track surface degradation prediction module 118 analyzes each particular channel of track geometry data 145 in order to identify specific locations on railroad track 120 that have defects that are progressively getting worse over time. For each specific defect location, track surface degradation prediction module 118 may apply logic (e.g., a remaining useful life model as discussed below) in order to determine a future time when the particular type of surface condition will exceed a predetermined limit. Based on the predicted future time that the predetermined limit will be exceeded, track surface degradation prediction module 118 may perform one or more actions such as automatically generating an alert or automatically dispatching a repair technician to repair the progressive defect location. As a result, railroad track 120 may be proactively repaired, thereby increasing the safety and availability of railroad track 120. Specific methods that may be utilized by track surface degradation prediction module 118 are discussed in more detail below with respect to FIG. 3.

FIG. 3 is a flow diagram illustrating an example method 300 for predicting railroad track surface degradation, according to certain embodiments. In some embodiments, the functions illustrated in the example blocks shown in FIG. 3 may be performed by track surface degradation prediction module 118 of FIG. 1 according to embodiments herein. In some embodiments, the operations of method 300 may be stored as instructions that, when executed by one or more processors, cause the one or more processors to perform the operations of method 300.

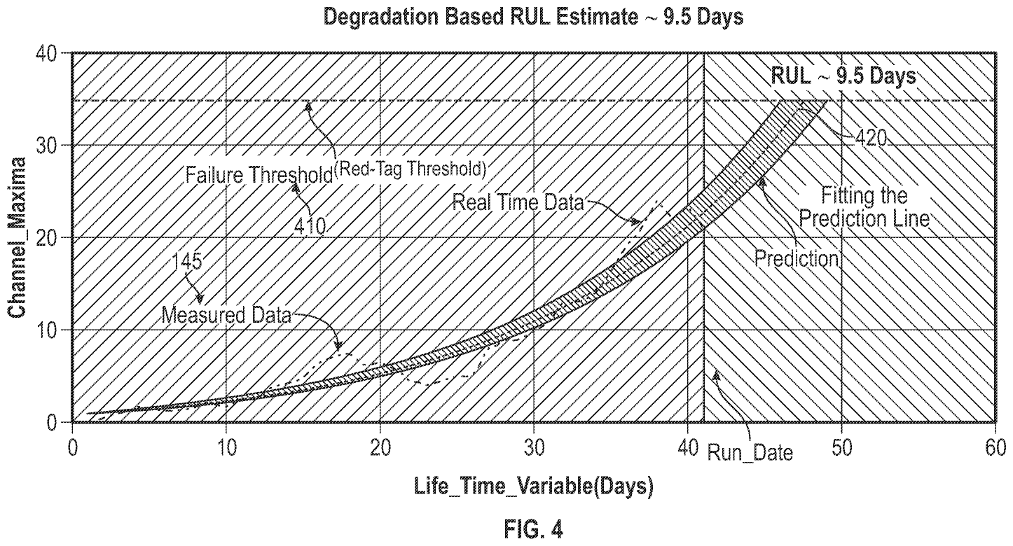

In general, method 300 analyzes track geometry data (e.g., track geometry data 145) for a railroad track and attempts to locate specific locations on the track with a surface condition that is getting progressively worse over time and is approaching a predetermined threshold. For example, FIG. 4 illustrates the overall operation of method 300. In this figure, the maxima of a specific channel of track geometry data (i.e., “Measured Data”) is plotted on a graph. The channel maxima is plotted on the Y-axis and the time (in days) is plotted on the X-axis. In this example, the channel maxima is rapidly approaching the failure threshold 410. The goal of method 300 is to analyze the measured data and fit a prediction line 420 in order to determine the remaining useful life (i.e., the amount of time left before the measured data for the channel crosses failure threshold 410). In this specific example, the fitted prediction line 420 crosses the failure threshold 410 at approximately 9.5 days in the future. Thus, method 300 determines that the remaining useful life is approximately 9.5 days. Specific embodiments of the operations used by method 300 to determine the remaining useful life are discussed in more detail below.

Returning to FIG. 3, method 300 may begin in step 310. In step 310, method 300 accesses track geometry data for a railroad track. In some embodiments, the track geometry data is track geometry data 145 that is stored in memory such as memory 115. The track geometry data includes historical measurements for a plurality of types of surface conditions of the railroad track over a period of time. In some embodiments, the types of surface conditions of the railroad track include a rise or depression in a left rail of the railroad track, a rise or depression in a right rail of the railroad track, and an amount of difference in elevation between top surfaces of the left and right rails of the railroad track. In some embodiments, the track geometry data is captured by a plurality of sensors of a geometry car while the geometry car travels over the railroad track. In some embodiments, the track geometry data is captured by a plurality of sensors of an aerial vehicle such as a drone. In some embodiments, the track geometry data accessed in step 310 is for a past amount of time (e.g., a six-month past window) from the current date for a given track subdivision and channel.

In step 320, method 300 determines, by analyzing the track geometry data for a particular type of surface condition, a plurality of measurements that exceed a predetermined value. For example, for a given track subdivision, channel, and date, the maxima/minima are collected which cross a certain preset channel value threshold (i.e., the peak max/min in either direction is collected). The preset channel value threshold may be configurable and may be different for each channel of data. As a specific example, the predetermined value for the threshold may be from 0.1 to 0.9 in either direction.

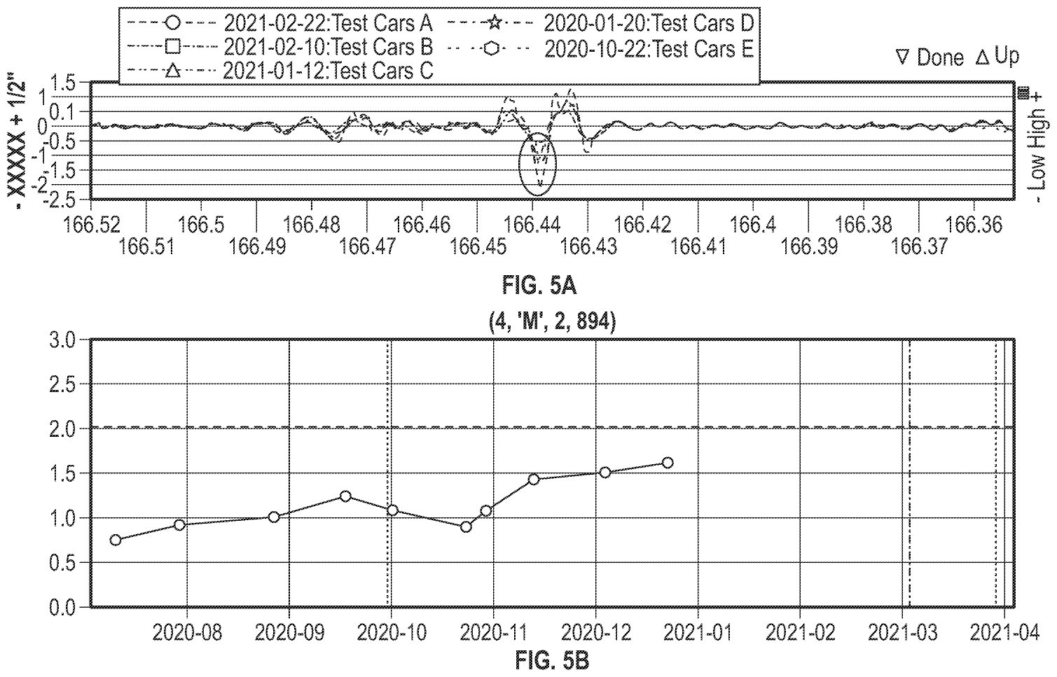

In step 330, method 300 identifies, by clustering the plurality of measurements of step 320 that exceed the predetermined value, a particular track location on the railroad track as a progressive defect location. In some embodiments, step 330 includes utilizing a clustering algorithm such as dbscan. In these embodiments, method 300 may first arbitrarily pick a point in the dataset until all points have been visited. If there are at least a set number of points (e.g., two) within a radius of ‘ε’ to the point, then method 300 considers all these points to be part of the same cluster. Radius ‘ε’ may vary for each channel of data (e.g., ε=200 FT for crosslevel, ε=3 FT for DIP, ε=3 FT for surface exceptions, etc.). Method 300 may then expand the clusters by recursively repeating the neighborhood calculation for each neighboring point. An example of the clustering of step 320 is illustrated in FIGS. 5A and 5B. FIG. 5A illustrates raw channel values with degradation of an LSURF defect near 166.44 milepost. Each plotted line is a channel measurement at a different point in time (e.g., a different pass of a geometry car 140B). As can be seen in the circled portion of this image, the peaks increase with time, which indicate that the region is degrading with time. FIG. 5B illustrates the maximum absolute values of the highlighted LSURF defect region from FIG. 5A at milepost 166.44. As method 300 takes the maximum absolute values from a particular localized defect, a linear trend of the data becomes readily visible in FIG. 5B. This data is then used by method 300 to fit a regression line to predict the future failure date, as explained in more detail below.

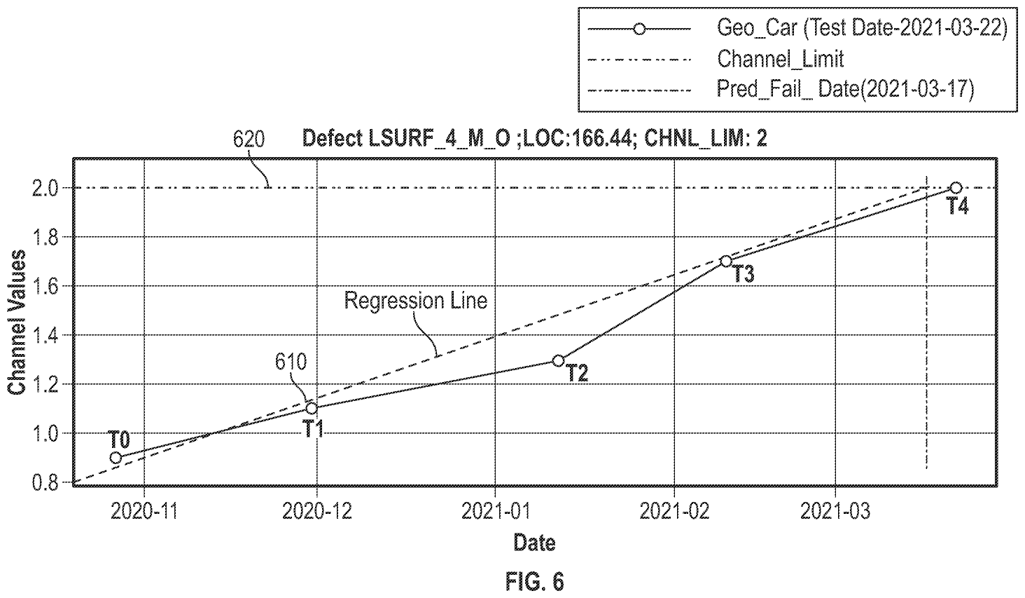

At step 340, method 300 determines, using a remaining useful life model and the track geometry data for the particular type of surface condition at the progressive defect location, a future time when the particular type of surface condition at the progressive defect location will exceed a predetermined limit. In general, method 300 in step 340 iterates over each clustered/identified defect location of step 330 which has a history of increasing defect amplitude in order to make a prediction of the remaining useful life. As a specific example for illustrative purposes only, consider the channel data plotted in FIG. 6. In this figure, channel values for a specific defect (i.e., LSURF) at a specific location (i.e., 166.44 milepost) are plotted over time (i.e., T0-T3). Method 300 may perform three distinct operations in order to calculate regression line 610 and determine future time T4 where regression line 610 crosses predetermined channel limit 620. The three distinct operations that may be performed by certain embodiments of method 300 in step 340 are discussed below.

The first operation that may be performed by certain embodiments of method 300 in step 340 is to calculate a correlation coefficient. In general, the correlation coefficient indicates the direction of the relationship, the form (shape) of the relationship, and the degree (strength) of the relationship between two variables. In some embodiments, locations with a correlation coefficient above a certain correlation threshold are considered for predictions. The correlation threshold may be a value between 0.1 and 1.0. In some embodiments, correlation coefficients below the correlation threshold are not considered for prediction. In some embodiments, the correlation coefficient may be calculated according to the formula below:

$$r = \frac{Σ ( {x}_{i} - \overline{x} ) ( {y}_{i} - \overline{y} )}{\sqrt{{Σ ( {x}_{i} - \overline{x} )}^{2} {Σ ( {y}_{i} - \overline{y} )}^{2}}}$$

where:
r=correlation coefficient;
xᵢ=Values of x-variable (Time_Diff);
x̅=Mean of the values of x-variable (Time_Diff);
yᵢ=Values of y-variable (Channel_Vals);
y̅=Mean of the values of y-variable (Channel_Vals);
Time_Diff is the difference between every run date and the starting date (T0); and
Channel_Vals is the absolute channel value of each run date.

The second operation that may be performed by certain embodiments of method 300 in step 340 is to fit regression line 610. In general, regression line 610 (i.e., the line of best fit)=Regression of (Time_Diff/RANGE, log (Channel_Vals)). RANGE is the max-min of the date value of the X-axis of FIG. 6. In some embodiments, the two variables Time-Diff and Channel_Vals are normalized before applying model predictions so that they are comparable. Therefore, Time_Diff may be normalized with RANGE and Channel_Vals may be normalized with natural logarithm. Regression line 610 is fit such that it captures the trend of the two data (Time_Diff and Channel_Vals). The intercept is the point where regression line 610 crosses the Y-axis. The slope of the regression line gives the measure of its steepness and direction. Here, Xi is Time_Diff/Range and Yi is log (Channel_Vals). The Intercept and Slope values may be calculated from these using the equation below:

$${Y}_{i} = {β}_{0} + {β}_{1} {X}_{i}$$

where:
γᵢ=Dependent Variable;
β₀=Constant/Intercept;
β₁=Slope/Coefficient; and
Xᵢ=Independent Variable.

The third operation that may be performed by certain embodiments of method 300 in step 340 is to find the remaining useful life, which indicates a future time when the particular type of surface condition at the progressive defect location will exceed predetermined channel limit 620. In some embodiments, the remaining useful life (“rul”) may be calculated using the formula below:

$$r u l = \frac{( log ( X ) - INTERCEPT )}{( SLOPE * RA NGE )}$$

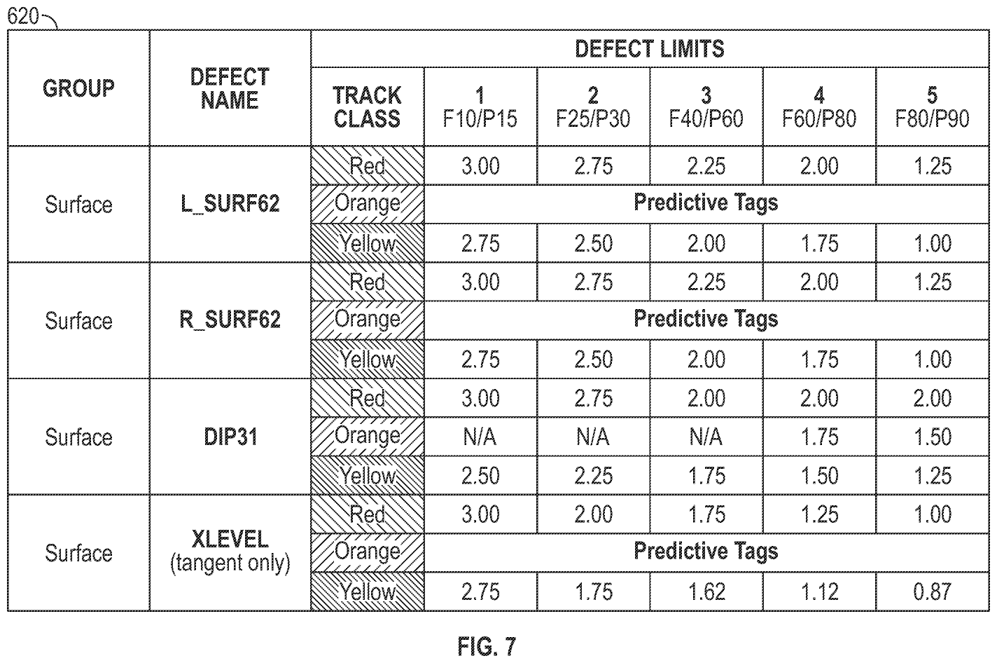

Here, “X” is the maximum channel value threshold 620 for a given location, track class, and channel and is a predetermined and configurable threshold. Examples of predetermined channel limits 620 are illustrated in FIG. 7. After step 340, method 300 may end.

In some embodiments, method 300 optionally includes initiating one or more actions based on the determined future time when the particular type of surface condition at the progressive defect location will exceed the predetermined limit. For example, method 300 may automatically electronically transmit, across a communications network, an alert for display on an electronic display. The alert may indicate the future time when the particular type of surface condition at the progressive defect location will exceed the predetermined limit. As another example, method 300 may automatically dispatch or schedule a repair technician to repair the progressive defect location.

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example, and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example, and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example, and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example, and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example, and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). For example, the terms “processor” and “controller” can be a class of structures, rather than one specific structure, and may be defined with functional terms, but that does not make it means-plus-function. Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the inventions can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules disclosed herein may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. The terms Disk and disc can include compact disc (CD), laser disc, optical disc, digital versatile disc (DVD), floppy disk, and Blu-ray disc where disks usually reproduce data magnetically, while discs usually reproduce data optically with lasers. Combinations of the above should also be included within the scope of computer-readable media.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function, in substantially the same way, or achieve substantially the same result as the corresponding embodiments described herein may be utilized according to the present invention. Accordingly, the appended claims are intended to include within their scope such processes, machines, manufacture, compositions of matter, means, methods, or steps.

1. A system comprising:
one or more memory units; and
one or more computer processors communicatively coupled to the one or more memory units and configured to:
access track geometry data for a railroad track, the track geometry data comprising historical measurements for a plurality of types of surface conditions of the railroad track over a period of time;
determine, by analyzing the track geometry data for a particular type of surface condition, a plurality of measurements that exceed a predetermined value;
identify, by clustering the plurality of measurements that exceed the predetermined value, a particular track location on the railroad track as a progressive defect location; and
determine, using a remaining useful life model and the track geometry data for the particular type of surface condition at the progressive defect location, a future time when the particular type of surface condition at the progressive defect location will exceed a predetermined limit.

2. The system of claim 1, wherein the plurality of types of surface conditions of rails of the railroad track comprises:
a rise or depression in a left rail of the railroad track;
a rise or depression in a right rail of the railroad track; and
an amount of difference in elevation between top surfaces of the left and right rails of the railroad track.

3. The system of claim 1, wherein the track geometry data is captured by a plurality of sensors of a geometry car while the geometry car travels over the railroad track.

4. The system of claim 1, wherein the track geometry data is captured by a plurality of sensors of an aerial vehicle.

5. The system of claim 1, the one or more computer processors further configured to automatically initiate one or more actions based on the determined future time when the particular type of surface condition at the progressive defect location will exceed the predetermined limit, the actions comprising:
automatically electronically transmitting, across a communications network, an alert for display on an electronic display; and
automatically dispatching or scheduling a repair technician to repair the progressive defect location.

6. The system of claim 1, wherein determining the future time when the particular type of surface condition at the progressive defect location will exceed the predetermined limit comprises:
calculating a correlation coefficient; and
fitting a regression line.

7. The system of claim 6, wherein the calculated correlation coefficient is compared to a correlation threshold prior to determining the future time when the particular type of surface condition at the progressive defect location will exceed the predetermined limit.

8. A method by a computing system, the method comprising:
accessing track geometry data for a railroad track, the track geometry data comprising historical measurements for a plurality of types of surface conditions of the railroad track over a period of time;
determining, by analyzing the track geometry data for a particular type of surface condition, a plurality of measurements that exceed a predetermined value;
identifying, by clustering the plurality of measurements that exceed the predetermined value, a particular track location on the railroad track as a progressive defect location; and
determining, using a remaining useful life model and the track geometry data for the particular type of surface condition at the progressive defect location, a future time when the particular type of surface condition at the progressive defect location will exceed a predetermined limit.

9. The method of claim 8, wherein the plurality of types of surface conditions of rails of the railroad track comprises:
a rise or depression in a left rail of the railroad track;
a rise or depression in a right rail of the railroad track; and
an amount of difference in elevation between top surfaces of the left and right rails of the railroad track.

10. The method of claim 8, wherein the track geometry data is captured by a plurality of sensors of a geometry car while the geometry car travels over the railroad track.

11. The method of claim 8, wherein the track geometry data is captured by a plurality of sensors of an aerial vehicle.

12. The method of claim 8, further comprising automatically initiating one or more actions based on the determined future time when the particular type of surface condition at the progressive defect location will exceed the predetermined limit, the actions comprising:
automatically electronically transmitting, across a communications network, an alert for display on an electronic display; and
automatically dispatching or scheduling a repair technician to repair the progressive defect location.

13. The method of claim 8, wherein determining the future time when the particular type of surface condition at the progressive defect location will exceed the predetermined limit comprises:
calculating a correlation coefficient; and
fitting a regression line.

14. The method of claim 13, wherein the calculated correlation coefficient is compared to a correlation threshold prior to determining the future time when the particular type of surface condition at the progressive defect location will exceed the predetermined limit.

15. One or more computer-readable non-transitory storage media embodying instructions that, when executed by a processor, cause the processor to perform operations comprising:
accessing track geometry data for a railroad track, the track geometry data comprising historical measurements for a plurality of types of surface conditions of the railroad track over a period of time;
determining, by analyzing the track geometry data for a particular type of surface condition, a plurality of measurements that exceed a predetermined value;
identifying, by clustering the plurality of measurements that exceed the predetermined value, a particular track location on the railroad track as a progressive defect location; and
determining, using a remaining useful life model and the track geometry data for the particular type of surface condition at the progressive defect location, a future time when the particular type of surface condition at the progressive defect location will exceed a predetermined limit.

16. The one or more computer-readable non-transitory storage media of claim 15, wherein the plurality of types of surface conditions of rails of the railroad track comprises:
a rise or depression in a left rail of the railroad track;
a rise or depression in a right rail of the railroad track; and
an amount of difference in elevation between top surfaces of the left and right rails of the railroad track.

17. The one or more computer-readable non-transitory storage media of claim 15, wherein the track geometry data is captured by a plurality of sensors of a geometry car while the geometry car travels over the railroad track.

18. The one or more computer-readable non-transitory storage media of claim 15, wherein the track geometry data is captured by a plurality of sensors of an aerial vehicle.

19. The one or more computer-readable non-transitory storage media of claim 15, the operations further comprising automatically initiating one or more actions based on the determined future time when the particular type of surface condition at the progressive defect location will exceed the predetermined limit, the actions comprising:
automatically electronically transmitting, across a communications network, an alert for display on an electronic display; and
automatically dispatching or scheduling a repair technician to repair the progressive defect location.

20. The one or more computer-readable non-transitory storage media of claim 15, wherein determining the future time when the particular type of surface condition at the progressive defect location will exceed the predetermined limit comprises:
calculating a correlation coefficient; and
fitting a regression line.
